(19) United States
(12) Patent Application Publication
(10) Pub. No.: US 2026/0059465 A1
(43) Pub. Date: Feb. 26, 2026

(54) USER EQUIPMENT POLICY MANAGEMENT AT TIME OF REGISTRATION IN A WIRELESS COMMUNICATIONS NETWORK

(71) Applicant: Lenovo (Singapore) Pte. Ltd., Singapore (SG)

(72) Inventors: Roozbeh Atarius, La Jolla, CA (US); Dimitrios Karampatsis, Ruislip (DE)

(21) Appl. No.: 19/102,365

(22) PCT Filed: Sep. 23, 2022
(86) PCT No.: PCT/EP2022/076576

§ 371 Date: Feb. 7, 2025

(30) Foreign Application Priority Data
Aug. 8, 2022 (GR) 20220100661

(51) Int. Cl. H04W 60/00; H04W 8/20

(52) U.S. Cl. CPC H04W 60/00; H04W 8/20

(57) ABSTRACT

Various aspects of the present disclosure relate to techniques for user equipment policy management. A method includes transmitting, to a first network entity, a registration request message comprising a requested UE policies information element, the registration request message identifying a second network entity; receiving, from the first network entity, a registration accept message; starting a first timer; and if a policy message is received from the second network entity via the first network entity before the first timer has reached a first time threshold, stopping the first timer or transmitting, to the second network entity via the first network entity, a reply message; or if the first timer has reached the first time threshold without a policy message being received from the second network entity via the first network entity, transmitting, to the second network entity via the first network entity, a UE policy provisioning request message.

### FIELD

The subject matter disclosed herein relates generally to the field of mobile networks, and more particularly to the requesting of service policies by devices at the time of device registration. This document defines a device, such as a user equipment device, and a method performed thereby, and a method performed by network entities in a mobile network.

### BACKGROUND

A user equipment (UE)-requested state indication is described in 3GPP TS 24.501 [1]. The UE-requested state indication is for the UE to provide a Policy Control Function (PCF) the information about its UE Policy Section Identifier (UPSI) list, Access Network Discovery and Selection Policy (ANDSP) support, and the identities of the operating systems (OS Ids) that the UE can support.

UE-requested state indication procedure is currently the only UE-PCF procedure that is performed at the time of the UE registration to the network and the procedure comprises only a single message, in particular a UE STATE INDICATION message, which is sent by the UE towards the PCF.

In order for the UE to request policy provisioning for services, such as Vehicle-to-Everything (V2X) or Proximity based Services (ProSe), the UE can perform UE-requested V2X policy provisioning procedure as specified in 3GPP TS 24.587 [2] and/or the UE-requested ProSe policy provisioning procedure as specified in 3GPP TS 24.554 [3]. These procedures are defined when the UE has successfully registered to the 5GS network.

### SUMMARY

There is no procedure described for the UE to request any policy provisioning at the time of the registration.

Disclosed herein are procedures for UE policy management at the time of registration.

There is provided a method performed by a device in a mobile network, the method comprising: transmitting, to a first network entity in the mobile network, a registration request message, the registration request message comprising a requested UE policies information element, the registration request message identifying a second network entity in the mobile network; receiving, from the first network entity, a registration accept message; responsive to receiving the registration accept message, starting a first timer; and either: if a policy message is received from the second network entity via the first network entity before the first timer has reached a first time threshold, stopping the first timer and/or transmitting, to the second network entity via the first network entity, a reply message; or if the first timer has reached the first time threshold without a policy message being received from the second network entity via the first network entity, transmitting, to the second network entity via the first network entity, a UE policy provisioning request message.

There is further provided a device for use in a mobile network, the device comprising: a transmitter arranged to transmit, to a first network entity in the mobile network, a registration request message, the registration request message comprising a requested UE policies information element and identifying a second network entity in the mobile network; a receiver arranged to receive, from the first network entity, a registration accept message; and a first timer; wherein the device is arranged to: responsive to receiving the registration accept message, start the first timer; and, responsive to the first timer reaching a first time threshold without a policy message being received from the second network entity via the first network entity, transmit, using the transmitter, to the second network entity via the first network entity, a UE policy provisioning request message.

There is further provided a method performed in a mobile network, the mobile network comprising a user equipment device, UE, a first network entity, and a second network entity, the method comprising: transmitting, by the UE to the first network entity in the mobile network, a registration request message, the registration request message comprising a requested UE policies information element, the registration request message identifying the second network entity; transmitting, by the first network entity to the second network entity, at least a part of the registration request message; transmitting, by the first network entity to the UE, a registration accept message; responsive to the UE receiving the registration accept message, starting, by the UE, a first timer; and either: if a policy message is received by the UE from the second network entity via the first network entity before the first timer has reached a first time threshold, stopping, by the UE, the first timer and/or transmitting, by the UE to the second network entity via the first network entity, a reply message; or if the first timer has reached the first time threshold without a policy message being received by the UE from the second network entity via the first network entity, transmitting, by the UE to the second network entity via the first network entity, a UE policy provisioning request message.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for UE policy management at the time of registration will now be described, by way of example only, with reference to the accompanying drawings, in which:

FIG. 1 is a schematic illustration of a wireless communication system;

FIG. 2 is a schematic illustration of a user equipment apparatus;

FIG. 3 is a schematic illustration of a network node;

FIG. 4 illustrates a UE-initiated UE state indication procedure;

FIG. 5 illustrates a UE-initiated UE state indication procedure when policy provisioning is requested;

FIG. 6 illustrates a network-requested UE policy management procedure;

FIG. 7 illustrates use of a timer for UE-initiated UE state indication procedure when policy provisioning is requested;

FIG. 8 is a process flow chart showing a UE policy management procedure at the time of registration;

FIG. 9 is a process flow chart showing a UE policy management procedure at the time of registration;

FIG. 10 is a process flow chart showing certain steps of a UE policy management procedure performed by a device, e.g. a UE; and

FIG. 11 is a process flow chart showing certain steps of a UE policy management procedure performed by entities within a mobile network.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram. The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

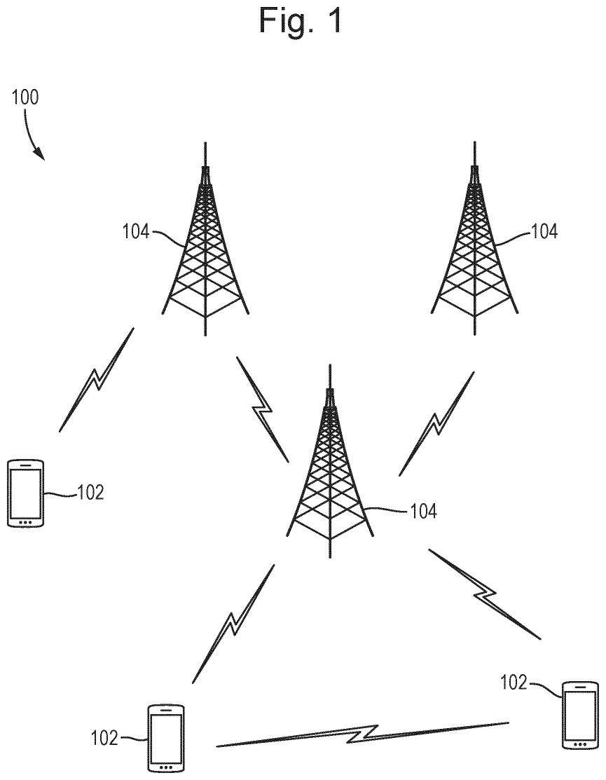

FIG. 1 depicts an embodiment of a wireless communication system 100 in which a method and apparatus for performing time management when requesting service policies at time of registration may be implemented. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

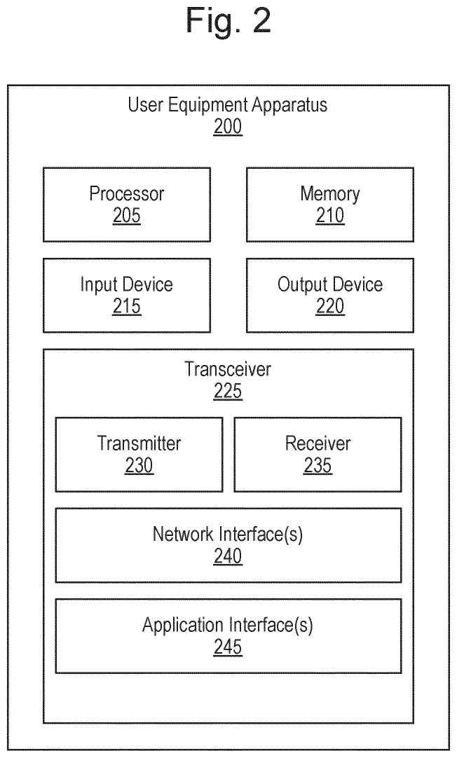

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. The user equipment apparatus 200 may be the same as or in accordance with the remote units 102 of FIG. 1. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

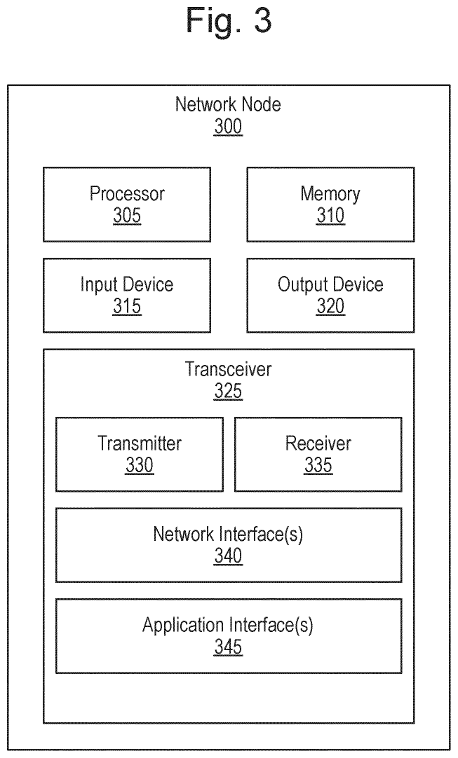

FIG. 3 depicts further details of the network node 300 that may be used for implementing the methods described herein. The network node 300 may be one implementation of an entity in the wireless communications network, e.g. in one or more of the wireless communications networks described herein. The network node 300 may be, for example, the UE 200 described above, or a Network Function (NF) or Application Function (AF), or another entity, of one or more of the wireless communications networks of embodiments described herein, e.g. the wireless communications network 100 of FIG. 1. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the Public Land Mobile Network (PLMN) and/or radio access network (RAN), as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

A user equipment (UE)-requested state indication is described in 3GPP TS 24.501 [1]. The UE-requested state indication is for the UE to provide a Policy Control Function (PCF) in the wireless communication network the information about its UE Policy Section Identifier (UPSI) list, Access Network Discovery and Selection Policy (ANDSP) support, and the identities of the operating systems (OS Ids) that the UE can support.

UE-requested state indication procedure is currently the only UE-PCF procedure that is performed at the time of the UE registration to the network and the procedure comprises only a single message, in particular a UE STATE INDICATION message, which is sent by the UE towards the PCF.

In order for the UE to request policy provisioning for services, such as Vehicle-to-Everything (V2X) or Proximity based Services (ProSe), the UE can perform UE-requested V2X policy provisioning procedure as specified in 3GPP TS 24.587 [2] and/or the UE-requested ProSe policy provisioning procedure as specified in 3GPP TS 24.554 [3]. These procedures are defined when the UE has successfully registered to the 5GS network.

There is currently no procedure for the UE to request any policy provisioning at the time of the registration. One way to resolve this is to include a new requested UE policies information element (IE) with the UE-requested state indication procedure. This may inform and trigger the PCF to manage the policies for UE service provision (e.g. the V2X and/or ProSe services) at the time of UE registration to the network. However, one challenge, if using a UE-requested state indication procedure, is that the procedure conventionally comprises only a request from the UE towards the PCF, and it does not have any response from the PCF. Therefore, if the UE does not receive any response from the PCF, it cannot know:
i) whether the PCF is a legacy PCF and does not support the requested services, e.g. V2XP or ProSeP provisioning; and/or
ii) whether the PCF does support the requested services, e.g. V2XP or ProSeP provisioning, but it does not support it at the time of the UE registration.

The only time the UE knows whether the PCF supports policy provisioning at the time of registration is when the UE receives the requested policies, such as V2XP and/or ProSeP, or a rejection with a related error code.

Currently, when a UE registers to a mobile network, the UE can send a UE STATE INDICATION message. This STATE INDICATION message informs the PCF about:
a) one or more stored UE policy section identifiers (UPSIs) comprising:
   1) PLMN identity for the PLMN of the PCF providing the policies; and
   2) UE policy section code (UPSC) comprising a value assigned by the PCF;
b) the UE's capability supporting ANDSP; and
c) UE's OS Ids.

This information is used by the PCF to provide the UE the basic policies for the selected PLMN. The UE STATE INDICATION message is transmitted during the network registration to the network and is included in the payload container and the payload container type is set to the value “UE policy container”. The message (i.e. the payload container containing the UE STATE INDICATION message) is transmitted towards the PCF via an AMF by using the REGISTRATION REQUEST message, more information on which is provided in 3GPP TS 24.501 [1].

When a UE supports V2X and/or ProSe, in order to request the PCF to provision policies for V2X and/or ProSe, the UE may currently perform UE-requested V2X policy provisioning procedure (for example, as specified in 3GPP TS 24.587 [2]) and/or the UE-requested ProSe policy provisioning procedure (for example, as specified in 3GPP TS 24.554 [3]). These procedures are based on the UE POLICY PROVISIONING REQUEST message comprising requested UE policies IE, which is included in the payload container information element with the payload container type set to the value “UE policy container” and transmitted towards the PCF via the AMF by using the UL NAS TRANSPORT message (see clause 5.4.5 of 3GPP TS 24.501 [1] for further information). The PCF may provision the UE by the policies, such as V2XP and/or ProSeP, by a MANAGE UE POLICY COMMAND message. Alternatively, the PCF may instead reject the request by transmitting the UE POLICY PROVISIONING REJECT message towards the UE. This reject message may comprise cause information, such as that disclosed in table 8.3.1.1 of 3GPP TS 24.587 [2], which is reproduced below:

TABLE 8.3.1.1
UPDS cause information element

| Cause value (octet 2) | | | | | | | | |
|---|---|---|---|---|---|---|---|---|
| Bits | | | | | | | | |
| 8 | 7 | 6 | 5 | 4 | 3 | 2 | 1 | |
| 0 | 0 | 0 | 1 | 1 | 1 | 1 | 1 | Request rejected, unspecified |
| 0 | 0 | 1 | 0 | 0 | 0 | 0 | 0 | Service option not supported |
| 0 | 0 | 1 | 0 | 0 | 0 | 1 | 0 | Service option temporarily |
| | | | | | | | | out of order |
| 0 | 0 | 1 | 0 | 0 | 0 | 1 | 1 | PTI already in use |
| 0 | 1 | 0 | 1 | 1 | 1 | 1 | 1 | Semantically incorrect message |
| 0 | 1 | 1 | 0 | 0 | 0 | 0 | 0 | Invalid mandatory information |
| 0 | 1 | 1 | 0 | 0 | 0 | 0 | 1 | Message type non-existent or |
| | | | | | | | | not implemented |
| 0 | 1 | 1 | 0 | 0 | 0 | 1 | 0 | Message type not compatible with |
| | | | | | | | | the protocol state |
| 0 | 1 | 1 | 0 | 0 | 0 | 1 | 1 | Information element non-existent |
| | | | | | | | | or not implemented |
| 0 | 1 | 1 | 0 | 0 | 1 | 0 | 0 | Conditional IE error |
| 0 | 1 | 1 | 0 | 1 | 1 | 1 | 1 | Protocol error, unspecified |

Any other value received by the UE shall be treated as 0010 0010, “service option temporarily out of order”. Any other value received by the network shall be treated as 0110 1111, “protocol error, unspecified”.

It is desired for the UE to request service provisioning, e.g. V2XP and/or ProSeP provisioning, at the time of the UE registration with the network. One way to implement this is to modify the contents of the UE STATE INDICATION message by adding a new information element, such as requested UE policies provisioning information element to request such policies. However, since currently the UE STATE INDICATION message does not elicit any response to the UE, it is not clear how the UE should proceed in cases where the UE does not receive any response back in the form of the provisioned policies or a rejection.

In this way, the semantic of the UE state indication procedure, which originally was designed to report the UE's state by adding the requested UE policies IE for requesting the UE policies for e.g. ProSe, V2X or both at the time of the UE's registration, is modified. The direct request for the policy modifies the signalling flow of the UE-requested state indication procedure, since two-way communication between the UE and the PCF is now implemented when requesting for policies. There may be some backward compatibilities issues, since earlier releases of the PCF do not expect to get requested UE policies IE in the UE STATE INDICATION message even if the PCF has support for the policies for ProSeP and/or V2XP. It has been proposed to resolve this by creating a timer starting at the time of UE registration and upon its expiration assumes that the PCF does not support the requested UE policies IE in the UE STATE INDICATION message (see CR 4134 against 24.501 [4]). Thus, the UE needs to execute the UE-requested policy provisioning procedure to obtain the V2XP, ProSeP or both.

However, since providing policies for V2X communication is Release-17, then the PCF should support the new UE requested policies IE within the UE STATE INDICATION message. Therefore, a PCF which is not capable of V2XP but is capable of only ProSeP (Release-16) ignores this new IE within the UE STATE INDICATION message.

Also, the existing method, i.e. the existing UE-requested V2X policy and/or ProSe policy provisioning procedure, used by the UE to obtain the 5G ProSe policy (ProSeP) while the UE is already registered, allows the UE to repeat the procedure up to 4 times. This appears to be at odds with the proposed timer in CR 4134 against 24.501 [4], which appears to offer this to the UE only once, and then leaves it up to the UE to fall back to the existing method.

It may be assumed that the UE-requested policy provisioning request message is not lost over the air during the transmission between the UE and the gNB since the NAS signalling for UE-requested state indication procedure and the UE-requested ProSe/V2X policy provisioning procedures use RRC acknowledge mode (AM) by employing the logical dedicated control channel (DCCH) over signalling radio bearer 1 (SRB1), and so it may be guaranteed that the gNB receives the NAS messages. However, there may be other reasons that the UE is directed to request for policy provisioning up to 4 times before releasing the procedure. Therefore, abandoning the procedure after one iteration, as appears would be the case using the timer proposed in CR 4134 against 24.501 [+], may not be appropriate.

Even though there is an option for the UE to proceed with the execution of the UE-requested ProSe/V2X policy provisioning procedures, nevertheless the UE does not know if the network (PCF) supports V2X policy provisioning since if the network (PCF) did not respond due to lack of support for the new requested UE policies IE for the UE state indication procedure and thereby the V2XP and ProSeP provisioning at the registration, then the network (PCF) might be Rel-16 PCF which does not support V2X policy provisioning even if using the UE-requested V2X policy provisioning procedure.

It is reasonable to assume that the AMF knows whether the PCF supports the new requested UE policies IE at the registration of the UE with the network, and thereby whether the network supports V2XP and/or ProSeP provisioning at the registration. Since the UE declares its support for services such as V2X and ProSe, the AMF can use the network repository function (NRF) to, based on network function (NF) and NF service discovery or local configuration, discover the network entities including PCF with capabilities for V2X and thereby the PCF capabilities for V2XP and/or ProSeP at the registration. The reader is directed to 3GPP TS 23.501 [5], 3GPP TS 29.510 [6] and 3GPP TS 29.507 [7], for more information. Therefore, the AMF is aware if the network entities such as PCF, have capabilities for V2X and thereby being Rel-17 PCF and having capabilities for UE-requested V2X policy provisioning or ProSe policy provisioning at the UE registration. A PCF in accordance with Rel-17 would support the new requested UE policies IE for the UE state indication procedure, and would understand the UE's request for policy provisioning at the network registration, and may implement or trigger network-requested a UE policy management procedure to transmit the V2XP and ProSeP towards the UE.

The AMF, in the registration accept message to the UE, can indicate to the UE the network capabilities for e.g. the V2X policy provisioning, including the PCF capability to understand the UE-requested policy provisioning request at the registration, and thereby:
provision the UE by initiating the network-requested UE policy management procedure; or
reject the UE's request with a related error code.

The present disclosure relates to a timer or timers that the UE may use, for example in cases where something went wrong in the PCF and/or backhaul meaning that the UE does not get any response to its policy provisioning request, if receiving the network indication that the feature is supported. Although preferably the timer(s) is used if the network indicates that it supports the policy provisioning at the time of UE registration with the network, advantageously, the timer(s) can also be used if the network indication is not employed in the AMF implementation.

In order for the UE to request the policy provisioning at the time of UE registration with the network, the UE may send to the PCF (e.g. via the AMF), the UE STATE INDICATION message. The UE STATE INDICATION message comprises the requested UE policies information element, which may be defined in Table 8.3.2.1 of 3GPP TS 24.587 [2], as the new IE. Thus, Table D.5.4.1.1 in 3GPP TS 24.501 [1] is expanded with the requested UE policies IE as shown below:

TABLE D.5.4.1.1
UE STATE INDICATION message content

| IEI | Information Element | Type/Reference | Presence | Format | Length |
|---|---|---|---|---|---|
| | PTI | Procedure transaction identity | M | V | 1 |
| | | 9.6 | | | |
| | UE STATE INDICATION | UE policy delivery service | M | V | 1 |
| | message identity | message type | | | |
| | | D.6.1 | | | |
| | UPSI list | UPSI list | M | LV-E | 9-65531 |
| | | D.6.4 | | | |
| | UE policy classmark | UE policy classmark | M | LV | 2-4 |
| | | D.6.5 | | | |
| 41 | UE OS Id | OS Id | O | TLV | 18-242 |
| | | D.6.6 | | | |
| | Requested UE policies | Requested UE policies | O | LV | 3-4 |

NOTE:
The total length of the UE STATE INDICATION message content cannot exceed 65535 octets (see Payload container contents maximum length as specified in subclause 9.11.3.39.1).

In the above table, the letter “M” in the Presence column may indicate a mandatory item, whereas the letter “o” may indicated an optional item.

The Requested UE policies information element may be a type 4 information element with a minimum length of 3 octets and a maximum length of 4 octets, and may be as defined in clause 8.3.2 in 3GPP TS 24.587 [5] as:

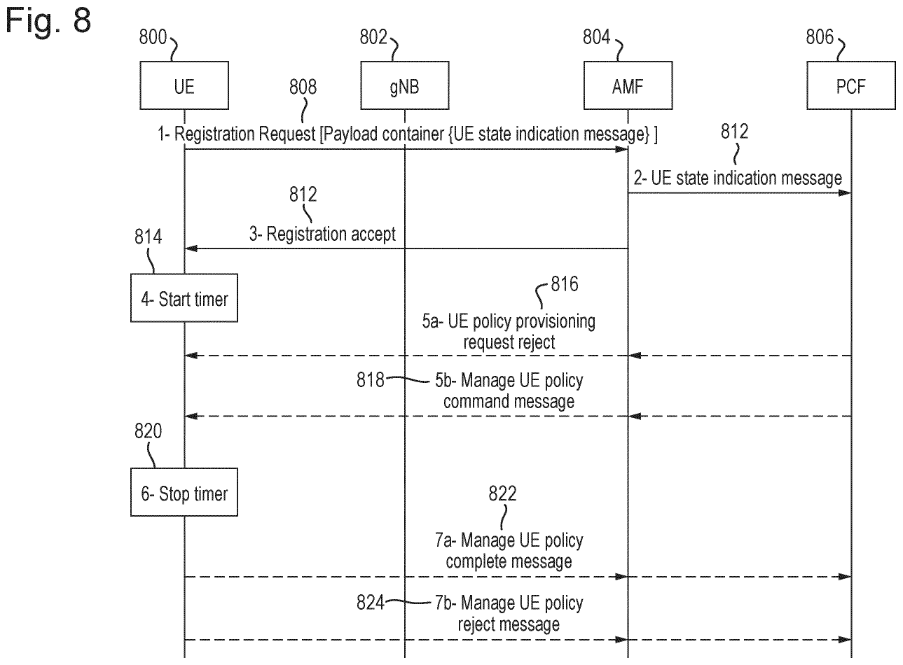

FIG. 8.3.2.1: Requested UE policies information element

| 8 | 7 | 6 | 5 | 4 | 3 | 2 | 1 | |
|---|---|---|---|---|---|---|---|---|
| Requested UE policies IEI | | | | | | | | octet 1 |
| Length of Requested UE policies contents | | | | | | | | octet 2 |
| 5P2RMI | 5P3RMI | 5P2UNRI | 5P3UNRI | 5PDCI | 5PDDI | V2XUUI | V2XPC5I | octet 3 |
| 0 | 0 | 0 | 0 | 0 | 0 | 0 | 0 | octet 4* |
| Spare | Spare | Spare | Spare | Spare | Spare | Spare | Spare | |

TABLE 8.3.2.1
Requested UE policies information element
UE policies for V2X communication over PC5 indicator
(V2XPC5I) (octet 3, bit 1)

| Bit | |
|---|---|
| 1 | |
| 0 | UE policies for V2X communication over PC5 not requested |
| 1 | UE policies for V2X communication over PC5 requested |

UE policies for V2X communication over Uu indicator
(V2XUUI) (octet 3, bit 2)

| Bit | |
|---|---|
| 2 | |
| 0 | UE policies for V2X communication over Uu not requested |
| 1 | UE policies for V2X communication over Uu requested |

UE policies for 5G ProSe direct discovery indicator
(5PDDI) (octet 3, bit 3) (see NOTE)

| Bit | |
|---|---|
| 3 | |
| 0 | UE policies for 5G ProSe direct discovery not requested |
| 1 | UE policies for 5G ProSe direct discovery requested |

UE policies for 5G ProSe direct communications
indicator (5PDCI) (octet 3, bit 4) (see NOTE)

| Bit | |
|---|---|
| 4 | |
| 0 | UE policies for 5G ProSe direct communications not requested |
| 1 | UE policies for 5G ProSe direct communications requested |

UE policies for 5G ProSe Layer-3 UE-to-network relay
indicator (5P3UNRI) (octet 3, bit 5) (see NOTE)

| Bit | |
|---|---|
| 5 | |
| 0 | UE policies for 5G ProSe Layer-3 UE-to-network relay not requested |
| 1 | UE policies for 5G ProSe Layer-3 UE-to-network relay requested |

UE policies for 5G ProSe Layer-2 UE-to-network relay
indicator (5P2UNRI) (octet 3, bit 6) (see NOTE)

| Bit | |
|---|---|
| 6 | |
| 0 | UE policies for 5G ProSe Layer-2 UE-to-network relay not requested |
| 1 | UE policies for 5G ProSe Layer-2 UE-to-network relay requested |

UE policies for 5G ProSe Layer-3 Remote UE indicator
(5P3RMI) (octet 3, bit 7) (see NOTE)

| 7 | |
|---|---|
| 0 | UE policies for 5G ProSe Layer-3 Remote UE not requested |
| 1 | UE policies for 5G ProSe Layer-3 Remote UE requested |

UE policies for 5G ProSe Layer-2 Remote UE indicator
(5P2RMI) (octet 3, bit 8) (see NOTE)

| 8 | |
|---|---|
| 0 | UE policies for 5G ProSe Layer-2 Remote UE not requested |
| 1 | UE policies for 5G ProSe Layer-2 Remote UE requested |

Bits of octet 4 are spare and shall be coded as zero if included.
NOTE:
Usage of this bit is not specified in the present specification and is specified in 3GPP TS 24.554 [27].

At the time of registration with the network, the UE may include the new expanded UE status indication message in the payload container of the registration request message, with the payload container type set to value “UE policy container”, when constructing the register request message. This may be as defined in 3GPP TS 24.501 [1].

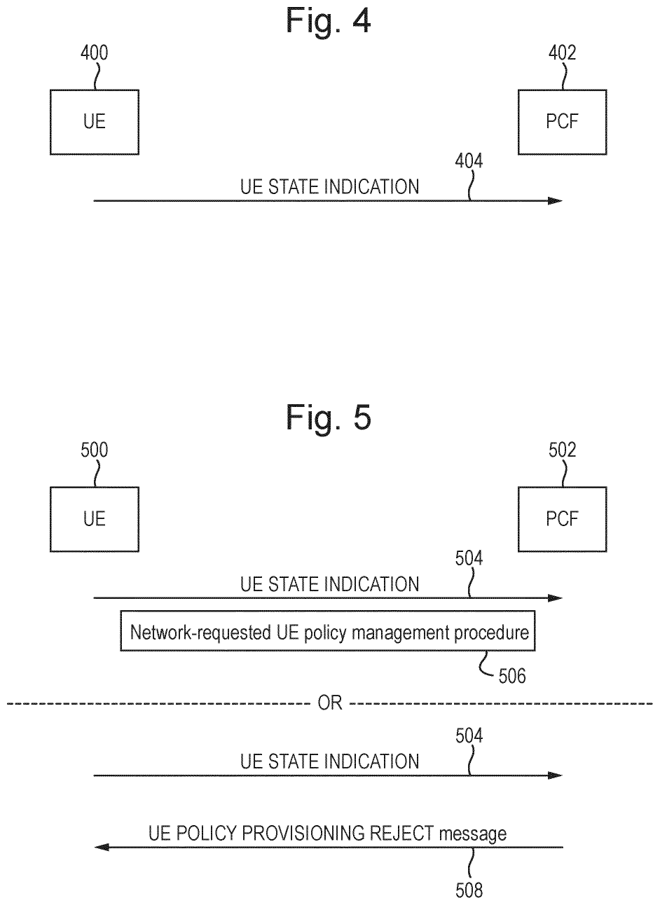

Currently, the procedure for the UE-requested state indication procedure is as described in Figure D.2.2.2.1 in 3GPP TS 24.501 [1]. This figure is provided in FIG. 4.

FIG. 4 shows the UE 400, the PCF 402, and the UE STATE INDICATION message 404 being sent from the UE 400 to the PCF 402.

However, with expanding the UE STATE INDICATION message to also include the requested UE policies IE, if this IE is included in or with the UE STATE INDICATION message, and if the network supports the IE, procedure is modified to that schematically illustrated in FIG. 5.

FIG. 5 shows the UE 500, the PCF 502, and the UE STATE INDICATION message 504 being sent from the UE 500 to the PCF 502. The UE STATE INDICATION message 504 may include or be sent with the requested UE policies IE. The network-requested UE policy management procedure 506 may be implemented after the sending of the UE STATE INDICATION message 504 from the UE 500 to the PCF 502. Alternatively, after the sending of the UE STATE INDICATION message 504 from the UE 500 to the PCF 502, the PCF 502 may send a US POLICY PROVISIONING REJECT message 508 to the UE 500. The UE POLICY PROVISIONING REJECT message may be as defined in 3GPP TS 24.587 [2].

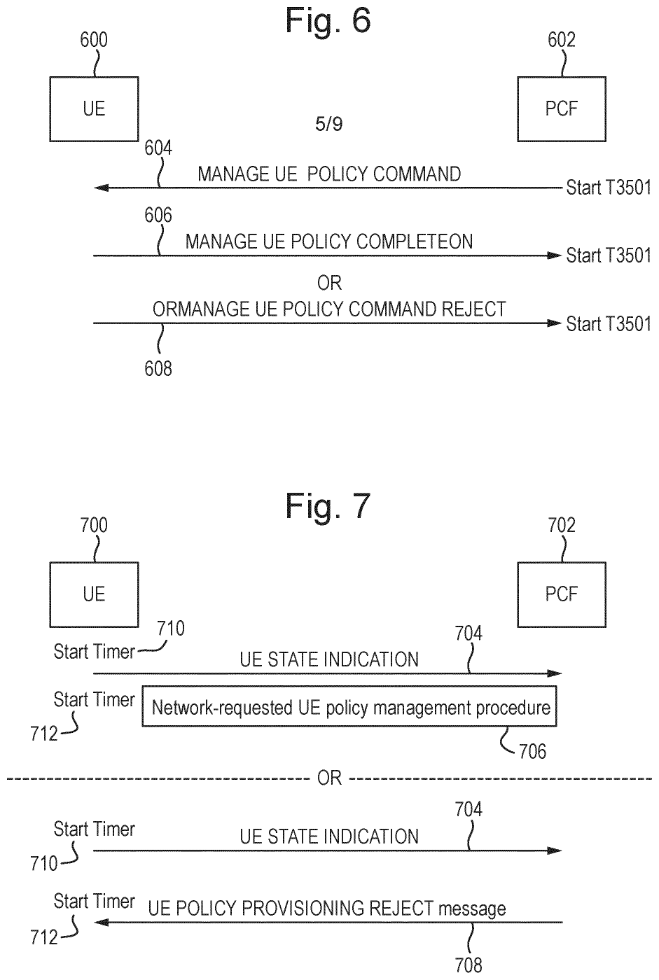

The network-requested UE policy management procedure may be as defined in clause D.2.1.2 of GPP TS 24.501 [1]. Three messages can be exchanged between the UE and the PCF, as shown in FIG. 6, which is in accordance with Figure D.2.1.2.1 of in GPP TS 24.501 [1].

FIG. 6 is a schematic illustration showing the UE 600 and the PCF 602. FIG. 6 further shows a MANAGE UE POLICY COMMAND message 604 being sent from the PCF 602 to the UE 600. FIG. 6 further shows, responsive to the UE 600 receiving the MANAGE UE POLICY COMMAND message 604 from the PCF 602, the UE 600 sends, to the PCF 602, either a MANAGE UE POLICY COMPLETE message 606 or a MANAGE UE POLICY COMMAND REJECT message 608.

A legacy PCF may not be required to support the policy provisioning at the UE's registration to the network. Thus, the PCF may ignore the new requested UE policies IE. Also, the UE's request message may not be responded to as a result of errors occurring in the core network such as in the PCF, or in the backhaul.

In embodiments described herein, one or more timers may be implemented to enable so the UE can use to stop and restart the process. Therefore, the procedure shown in described in FIG. 5 may become as illustrated in FIG. 7.

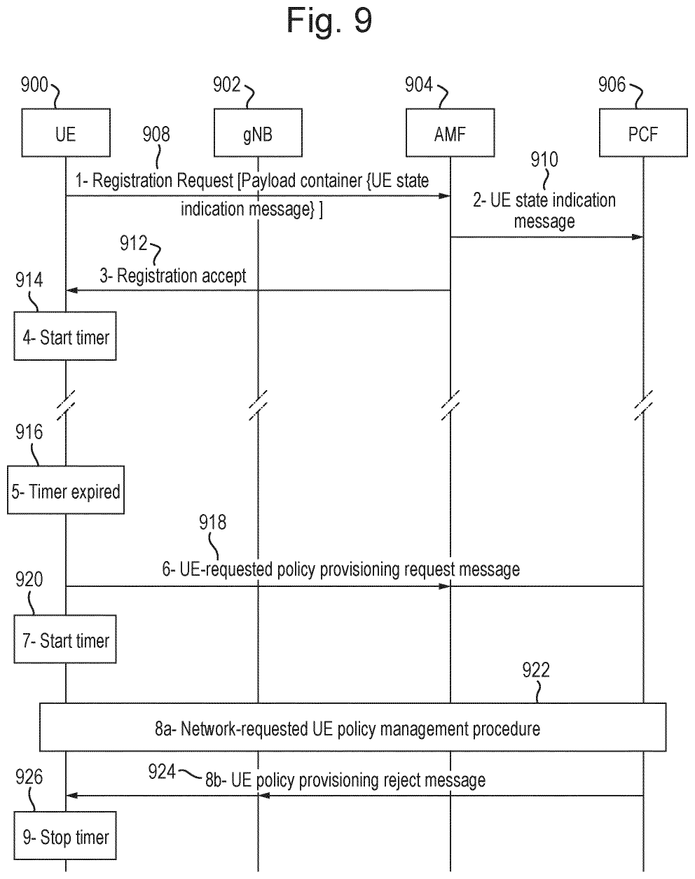

FIG. 7 shows the UE 700, the PCF 702. The UE STATE INDICATION message 704 is sent from the UE 700 to the PCF 702. The UE STATE INDICATION message 704 may include or be sent with the requested UE policies IE. The network-requested UE policy management procedure 706 may be implemented after the sending of the UE STATE INDICATION message 704 from the UE 500 to the PCF 702. Alternatively, after the sending of the UE STATE INDICATION message 704 from the UE 700 to the PCF 702, the PCF 702 may send a US POLICY PROVISIONING REJECT message 708 to the UE 700. The UE 700 may start 710 and stop 712 one or more timers responsive to the messages being send and/or received, for example as described in more detail later below with reference to FIGS. 8 and 9.

FIG. 8 is a process flow diagram illustrating an embodiment of a UE policy management procedure at the time of UE registration with the network.

In this embodiment, the UE policy management procedure of FIG. 8 involves the following network entities: a UE 800, a base station gNB 802, an AMF 804, and a PCF 806.

The UE 800 may be the same as or in accordance with any of the UEs described herein, such as the UE 200 shown in FIG. 2 and described in more detail earlier above.

The base station gNB 802, the AMF 804, and/or the PCF 806 may be the same as or in accordance with any network entity, function, or node described herein. For example, the gNB 802 may be the same as the network node 300 shown in FIG. 3 and described in more detail earlier above.

At step 808, at the time of registration with the network, the UE 800 sends a registration request to the AMF 804 (e.g. via the gNB 802). The registration request may include a payload container with the payload container type set to the value “UE policy container”. The payload container may container the modified version of the UE state indication message containing the information elements of the original UE state indication message (e.g. as defined in Table D.5.4.1.1 in 3GPP TS 24.501 [1]) as well as the requested UE policies information element (e.g. as defined in table 8.3.2.1 of 3GPP TS 24.587 [2]).

At step 810, the AMF 804 transparently passes the contents of the payload container to the PCF 806.

At 812, the registration of the UE 800 with the network is successful, and the UE 800 receives, from the AMF 804, an indication or message that the registration is accepted.

At step 814, upon receipt of the indication that the registration is accepted, the UE 800 starts a timer, e.g. a first timer.

In this embodiment, the network indicates to the UE 800 at this stage whether the policy provisioning at the time of registration is supported by the network. The timer is used to support the policy provisioning feature, but additionally can be used to detect errors in the core network or the backhaul. Accordingly, in some embodiments, conditions or requirements for the UE starting the timer (e.g. the first timer) include the condition that the UE receives receipt of the registration being accepted and/or the network indicating its support for the policy provisioning at the time of the registration.

Following step 814, either step 816 or 818 is performed.

If the PCF 806 is to reject the UE policy provisioning request, for example due to certain issues which are listed in table 8.3.1.1 of 3GPP TS 24.587 [2], step 816 is performed. At step 816, the PCF 806 constructs the UE policy provisioning reject message, which may include appropriate UPDS cause values, and sends the UE policy provisioning reject message towards the UE 800 via the AMF 804.

Alternatively, if the PCF 806 is the transmit the requested UE policies (e.g. for the ProSe or V2X), step 818 is performed. At step 818, the PCF 806 constructs the manage UE policy command message, which may include a UE policy section management list information element with UE policies as described in clause D.6.2 in 3GPP TS 24.501 [1], and sends the manage UE policy command message towards the UE 800 via the AMF 804.

After either of step 816 or 818 is performed, the procedure continues to step 820.

At step 820, upon receipt of the UE policy provisioning reject or manage UE policy command message by the UE 800, the UE 800 stops the timer (e.g. the first timer).

Following step 820, either step 822 or 824 is performed.

If all received instructions in the manage UE policy command message have been successfully executed at the UE, step 822 is performed. At step 822, the UE constructs the manage UE policy complete message and transmits the manage UE policy complete message towards the PCF 806 (e.g. via the AMF 804).

Alternatively, if one or more received instructions in the manage UE policy command could not be successfully executed at the UE 800, step 824 is performed. At step 824, the UE constructs the manage UE policy command reject message and transmits the manage UE policy command reject message towards the PCF 806 (e.g. via the AMF 804). The manage UE policy command reject may include UE policy section management result to identify the one or more received instructions in the manage UE policy command which could not be successfully executed.

In the embodiments described herein, e.g. in the procedure of FIG. 8, the timer (e.g. the first timer) may reach or time to a first time threshold (e.g. if the first timer is a countdown timer, the first timer may expire or elapse) while the UE 800 has not received any policy message from the PCF 806 (e.g. either the UE policy provisioning reject message or the manage UE policy command message).

FIG. 9 is a process flow diagram illustrating an embodiment of a UE policy management procedure at the time of UE registration with the network, in which the timer (e.g. the first timer) reaches a first time threshold before the UE 800 receives any policy message from the PCF 806.

In this embodiment, the UE policy management procedure of FIG. 9 involves the following network entities: a UE 900, a base station gNB 902, an AMF 904, and a PCF 906. These network entities may be the same as those implemented on the procedure of FIG. 8.

The UE 900 may be the same as or in accordance with any of the UEs described herein, such as the UE 200 shown in FIG. 2 and described in more detail earlier above.

The base station gNB 902, the AMF 904, and/or the PCF 906 may be the same as or in accordance with any network entity, function, or node described herein. For example, the gNB 902 may be the same as the network node 300 shown in FIG. 3 and described in more detail earlier above.

At step 908, at the time of registration with the network, the UE 900 sends a registration request to the AMF 904 (e.g. via the gNB 902). The registration request may include a payload container with the payload container type set to the value “UE policy container”. The payload container may container the modified version of the UE state indication message containing the information elements of the original UE state indication message (e.g. as defined in Table D.5.4.1.1 in 3GPP TS 24.501 [1]) as well as the requested UE policies information element (e.g. as defined in table 8.3.2.1 of 3GPP TS 24.587 [2]).

At step 910, the AMF 904 transparently passes the contents of the payload container to the PCF 906.

At 912, the registration of the UE 900 with the network is successful, and the UE 900 receives, from the AMF 904, an indication or message that the registration is accepted.

At step 914, upon receipt of the indication that the registration is accepted, the UE 900 starts a timer, e.g. a first timer.

In this embodiment, the network indicates to the UE 900 at this stage whether the policy provisioning at the time of registration is supported by the network. The timer is used to support the policy provisioning feature, but additionally can be used to detect errors in the core network or the backhaul. Accordingly, in some embodiments, conditions or requirements for the UE starting the timer (e.g. the first timer) include the condition that the UE receives receipt of the registration being accepted and/or the network indicating its support for the policy provisioning at the time of the registration. Following step 814, either step 816 or 818 is performed.

In this embodiment, at step 916 the timer (e.g. the first timer) reaches or times to a first time threshold (e.g. if the first timer is a countdown timer, the first timer may expire or elapse) while the UE 800 has not received any (policy) message from the PCF 806 (e.g. either the UE policy provisioning reject message or the manage UE policy command message).

At step 918, the UE 900 initiates a UE-requested policy provisioning procedure, such as the UE-requested V2X policy provisioning procedure as specified in 3GPP TS 24.587 [2] and/or the UE-requested ProSe policy provisioning procedure as specified in 3GPP TS 24.554 [3]. The UE 900 transmits the UE-requested policy provisioning request message towards the PCF 916 (e.g. via the AMF 904).

At step 920, upon transmission of the UE-requested policy provisioning request message, the UE 900 starts the timer (which may be a second timer).

After step 920, either step 922 or step 924 is performed.

If the network accepts the procedure, step 922 is performed. At step 922, upon receipt of the UE-requested policy provisioning request message, the PCF 906 initiates the network-requested UE policy management procedure, such as that as defined in clause D.2.1.2 of GPP TS 24.501 [1] to provision the UE 900 by the V2XP and/or ProSeP.

Alternatively, if the network does not accept the procedure, step 924 is performed. At step 924, the PCF 906 rejects by transmitting the UE policy provisioning reject message.

After step 922 or step 924 is performed, the procedure continues to step 926. At step 926, upon receipt of the manage UE policy command message from the network-requested UE policy management procedure or the UE policy provisioning reject message, the UE 900 stops the timer (e.g. the second timer).

In this embodiment, the timer (e.g. the second timer) may reach or time to a second time threshold, which may be the same as or different to the first time threshold, without the UE 900 receiving any (policy) policy message from the PCF 906, such as the manage UE policy command message or the UE policy provisioning reject message. For example, the second timer may elapse, expire, or time-out before the UE 900 receives a message from the PCF 906. In such a case, the UE 900 may yet again initiate the UE-requested policy provisioning procedure, such as the UE requested V2X policy provisioning procedure as specified in 3GPP TS 24.587 [2] and/or the UE-requested ProSe policy provisioning procedure as specified in 3GPP TS 24.554 [3], and may yet again transmit the UE-requested policy provisioning request message towards the PCF 906. The UE 900 thereby re-starts the timer (e.g. the second timer). The UE may repeatedly perform this process until either it receives a policy message from the PCF 906, or until it reaches a threshold number of attempts (e.g. a maximum of four attempts). Thus, the UE 900 may make several attempts at achieving policy provisioning (i.e. may make multiple initiations of the UE-requested policy provisioning procedure), up to a limited number of times (e.g. 4).

In the embodiments described herein, if the UE knows that the PCF does not support the requested UE policies IE in the UE STATE INDICATION message, the UE does not need to use the timer(s). This may be due to the PCF ignoring the requested UE policies IE in the UE STATE INDICATION message upon its reception. The UE may know about the PCF capability for handling the requested UE policies IE in the UE STATE INDICATION message by the AMF informing the UE that the network is capable of handling V2X in the registration accept message. If the PCF is capable of V2X policy provisioning, then the PCF is a Release 17 PCF. Being a Release 17 PCF may mean that the PCF is capable of handling the requested UE policies IE within the UE STATE INDICATION IE if this feature is introduced in Release 17 of the technical specification, comprising 3GPP TS 24.501 [1].

If the timer(s) is used by the UE and the UE is not aware of the PCF support requested UE policies IE in the UE STATE INDICATION message, and if the timer(s) has expired while the UE has not received a (policy) message from the PCF, the UE may conclude that one or more of the following has occurred:
the PCF does not support the requested UE policies IE in the STATE INDICATION message (e,g, the PCF is not a Release 17 PCF); and an error has occurred within the core network or the backhaul.

If the timer is used by the UE and the UE is aware of the PCF support requested UE policies IE in the UE STATE INDICATION message, and if the timer has expired while the UE has not received a (policy) message from the PCF, the UE may conclude that an error has occurred within the core network or the backhaul.

After the expiration of the timer, the UE may request again by transmitting a UE POLICY PROVISIONING REQUEST message comprising the requested UE policies IE. Since this message is supported in earlier releases of the PCF, then if the UE does not receive any response in the form of a MANAGE UE POLICY COMMAND or a rejection, then the UE may conclude an error has occurred within the core network or the backhaul.

Even if the PCF is an earlier release and does not support V2XP provisioning, the PCF can reject the request with a UPSD cause information element with a cause value indicating a lack of support for the service option V2X.

The UE can either (i) retransmit the UE POLICY PROVISIONING REQUEST message comprising requested UE policies IE, or (ii) if the UE has already requested the limited number of times (e.g. 4 times), release or end the procedure by not sending any more requests for policy provisioning.

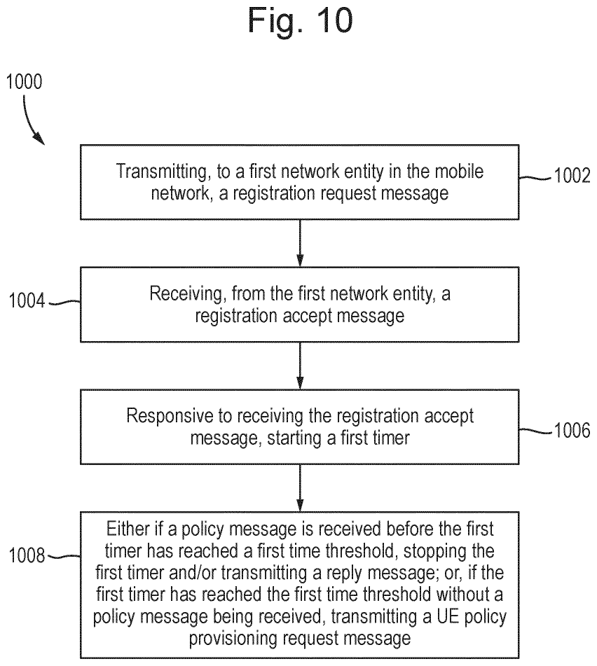

In an embodiment, there is provided a method performed by a device in a mobile network. The device may be a user equipment, UE, apparatus such as a UE as disclosed herein, e.g. a UE 200, 800, 900 as described in more detail earlier above. FIG. 10 is a process flow chart showing this method 1000. The method 1000 comprises: transmitting 1002, to a first network entity (e.g. an AMF) in the mobile network, a registration request message, the registration request message comprising a requested UE policies information element, the registration request message identifying a second network entity (e.g. a PCF) in the mobile network; receiving 1004, from the first network entity, a registration accept message; and, responsive to receiving the registration accept message, starting 1006 a first timer; and, at 1008, either:
if a policy message is received from the second network entity (e.g. via the first network entity) before the first timer has reached a first time threshold, stopping the first timer and/or transmitting, for use by the second network entity (e.g. via the first network entity), a reply message; or
if the first timer has reached the first time threshold without a policy message being received from the second network entity (e.g. via the first network entity), transmitting, for use by the second network entity (e.g. via the first network entity), a UE policy provisioning request message.

A payload container IE with a related payload container type IE may be in the registration request message. The contents of the payload container IE may be transparent to the AMF, but if the payload container type IE is set to the value “UE policy container” (see table 9.11.3.40.1 in TS 24.501 for more information), then the AMF may determine that the contents of the payload container IE must be forwarded to a PCF.

The content of the payload container for the payload container type “UE policy type” at the registration is the UE STATE INDICATION message with IEs which may be as defined in Table D.5.4.1.1 of TS 24.501.

Preferably, feasibility for the UE to request the policy provisioning for V2X (which is Rel-17) and ProSe (which is Rel-16) at the initial registration is provided. One way in which this may be achieved is to add the requested UE policies IE (which may be as defined in TS 24.587) to the UE STATE INDICATION message. The requested UE policies IE has already been used in UE-requested policy provisioning procedure for V2X and ProSe in TS 24.587 and TS 24.554, however the UE-requested policy provisioning is when the UE is already registered and is not performed at the initial registration.

The identity of the second network entity may be specified implicitly, for example, within the value of the payload container type IE.

The first timer may be started if an indication is received by the device from the first network entity, wherein the indication is for the second network entity supporting policy provisioning for a service wherein the policy provisioning for the service is defined at initial registration to 5GS.

The registration request message may comprise a first payload container comprising a UE state indication message. The UE state indication message may comprise: information elements (such as those defined in Table D.5.4.1.1 in 3GPP TS 24.501 [1]), and/or a requested UE policies information element (such as that defined in table 8.3.2.1 of 3GPP TS 24.587 [2]).

The registration request message may comprise a first payload container having a payload container type set to a value of UE policy container. This may be as defined in 3GPP TS 24.501 [1].

The registration request message may comprise a first payload container having a payload container type that identifies the second network entity.

The registration request message may be arranged to trigger a UE-requested V2X policy provisioning procedure as specified in 3GPP TS 24.587 [2] and/or a UE-requested ProSe policy provisioning procedure as specified in 3GPP TS 24.554 [3].

The policy message may comprises either: a rejection (e.g. a UE policy provisioning reject message); or a command or request (e.g. a manage UE policy command message) that the device provides a response for the second network entity.

The policy message may comprise the command or request that the device provides a response to the second network entity, and the method may further comprise either:
transmitting, to the second network entity (e.g. via the first network entity), a first reply message (e.g. a manage UE policy complete message) if all received instructions in the command or request have been successfully executed at the device; or
transmitting, to the second network entity (e.g. via the first network entity), a second reply message (e.g. a manage UE policy command reject message) if one or more received instructions in the command or request have not been successfully executed at the device.

The UE policy provisioning request message may comprise a requested UE policies information element (such as that defined in table 8.3.2.1 of 3GPP TS 24.587 [2]). This may be transmitted in a second payload container of a UL NAS transport message (such as that defined in clause 5.4.5 of 3GPP TS 24.501 [1]).

The UL NAS transport message may comprise a second payload container having a payload container type set to a value of UE policy container (e.g. as defined in 3GPP TS 24.501 [1]).

The method may further comprise, if the first timer has reached the first time threshold without the policy message being received from the second network entity (e.g. via the first network entity), starting a second timer.

The method may further comprise, if the first timer has reached the first time threshold without the policy message being received from the second network entity (e.g. via the first network entity), retransmitting, to the second network entity via the first network entity, the UE policy provisioning request message.

The method may further comprise, responsive to the second timer reaching a second time threshold without the policy message being received from the second network entity (e.g. via the first network entity), transmitting, to the second network entity (e.g. via the first network entity), the UE policy provisioning request message, and, optionally, restarting the second timer.

In some embodiments, transmission of the UE policy provisioning request message is only attempted a limited number of times (e.g. 4 time) and if a command or a rejection has not been received. The rejection may comprise a UPDS cause information element comprising a cause value, which may as defined in table 8.3.1.1 of 3GPP TS 24.587 [2].

The first network entity may be an Access and Mobility Management Function, AMF. The second network entity may be a Policy Control Function, PCF.

In a further embodiment, there is provided a device for use in a mobile network. The device may be a user equipment, UE, apparatus such as a UE as disclosed herein, e.g. a UE 200, 800, 900 as described in more detail earlier above. The device comprises: a transmitter arranged to transmit, to a first network entity in the mobile network, a registration request message, the registration request message comprising a requested UE policies information element and identifying a second network entity in the mobile network; a receiver arranged to receive, from the first network entity, a registration accept message; and a first timer. The device is arranged to: responsive to receiving the registration accept message, start the first timer; and, responsive to the first timer reaching a first time threshold without a policy message being received from the second network entity (e.g. via the first network entity), transmit, using the transmitter, for use by the second network entity (e.g. via the first network entity), a UE policy provisioning request message.

The device may be further arranged to, if the policy message is received from the second network entity (e.g. via the first network entity) before the first timer has reached a first time threshold, stop the first timer and/or transmit, using the transmitter, for use by the second network entity (e.g. via the first network entity), a reply message.

The device may further comprise a second timer. The device may be arranged to, if the first timer has reached the first time threshold without the policy message being received from the second network entity (e.g. via the first network entity), start the second timer, and to transmit, using the transmitter, for use by the second network entity (e.g. via the first network entity), the UE policy provisioning request message.

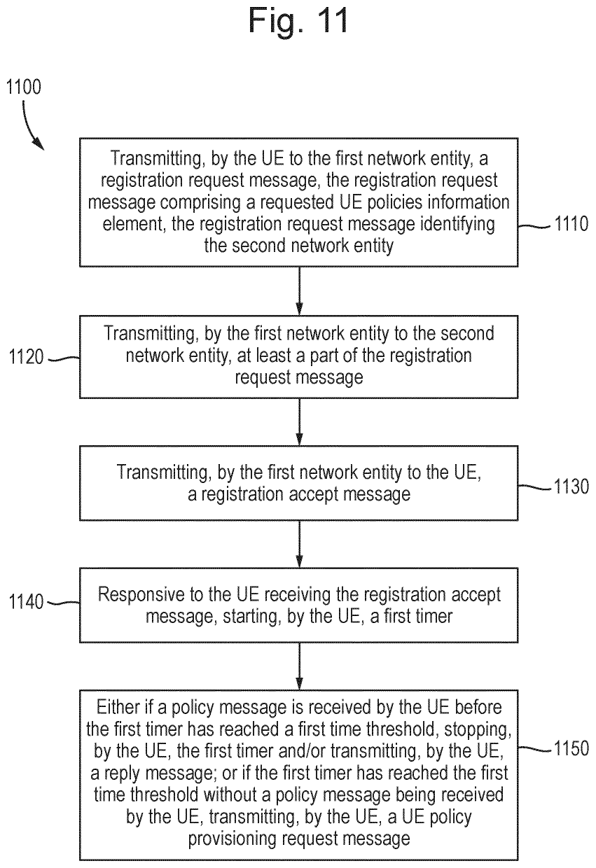

In a further embodiment, there is provided a method performed in a mobile network. FIG. 11 is a process flow chart showing this method 1100. The mobile network comprises a user equipment device, UE (e.g. a UE such as UE 200, 800, 900), a first network entity (e.g. an AMF), and a second network entity (e.g. a PCF). The method 1100 comprises: transmitting 1110, by the UE to the first network entity in the mobile network, a registration request message, the registration request message comprising a requested UE policies information element, the registration request message identifying the second network entity; transmitting 1120, by the first network entity to the second network entity, at least a part of the registration request message (e.g. the requested UE policies information element which may be contained in a payload container); transmitting 1130, by the first network entity to the UE, a registration accept message; responsive to the UE receiving the registration accept message, starting 1140, by the UE, a first timer; and, at 1150, either:
if a policy message is received by the UE from the second network entity (e.g. via the first network entity) before the first timer has reached a first time threshold, stopping, by the UE, the first timer and/or transmitting, by the UE to the second network entity (e.g. via the first network entity), a reply message; or
if the first timer has reached the first time threshold without a policy message being received by the UE from the second network entity (e.g. via the first network entity), transmitting, by the UE to the second network entity (e.g. via the first network entity), a UE policy provisioning request message.

The UE policy provisioning request message may be transmitted by the UE to the first network entity, and the first network entity transparently transmits the UE policy provisioning request message to the second network entity.

The method may further comprise, responsive to the second network entity receiving the at least a part of the registration request message, transmitting, by the second network entity, to the UE (e.g. via the first network entity), the policy message, the policy message comprising either: a rejection (e.g. a UE policy provisioning reject message); or a command or request (e.g. a manage UE policy command message) that the UE provides a response to the second network entity.

In embodiments described herein, if the PCF is capable of handling the requested UE policies information element during the UE-requested state indication procedure, one or more timers is implemented to indicate the UE to re-initiate the procedure for requesting for the policy provisioning. Advantageously, the timer(s) tend to be usable to determine or realize whether the network supports the policy provisioning at the time of the UE registration to the 5GC network.

The timer may be used in cases where the UE cannot be informed in the registration accept message whether the PCF is capable of handling the requested UE policies information element during the UE-requested state indication procedure. In such cases, if the timer is expired after the first request without the UE receiving any message from the network, either the network does not support policy provisioning at the registration, or there is an error in the network.

If the timer for the second request for policy provisioning is expired, then there may be an error in the network.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations may be useful to the reader:

| | |
|---|---|
| 5GCN | 5G Core Network |
| 5GS | 5G System |
| AMF | Access and Mobility Management Function |
| ANDSP | Access Network Discovery and Selection Policy |
| APN | Access Point Name |
| BRID | Broadcast Remote Identification |
| BVLOS | Beyond Visual Line of Sight |
| C2 | Command and Control |
| CAA | Civil Aviation Administration |
| DCCH | Dedicated Control CHannel |
| DCN | Dedicated Core Network |
| DNN | Data Network Name |
| DNS | Domain Name System |
| ePDG | evolved Packet Data Gateway |
| ePCO | Extended Protocol Configuration Options |
| EPS | Evolved Packet System |
| ER-NSSAI | Extended rejected NSSAI |
| E-UTRA | Evolved Universal Terrestrial Radio Access |
| FQDN | Fully Qualified Domain Name |
| GUMMEI | Globally Unique Mobility Management Entity Identifier |
| GUTI | Globally Unique Temporary Identity |
| HSS | Home Subscriber Server |
| IE | Internet Element |
| IMSI | International Mobile Subscriber Identity |
| IP | Internet Protocol |
| LCS | LoCation Services |
| N3AN | Non-3GPP Access Network |
| N3IWF | Non-3GPP InterWorking Function |
| NEF | Network Exposure Function |
| NID | Network Identifier |
| OS Id | Operating System Identity |
| OS App Id | Operating System Application Identity |
| PCF | Policy Control Function |
| PCO | Protocol Configuration Options |
| PDN | Packet Data Network |
| PDN GW | PDN Gateway |
| PDU | Protocol Data Unit |
| PGW | PDN GW |
| PLMN | Public Land Mobile Network |
| PLMN ID | Public Land Mobile Network identity |
| MCC | Mobile Country Code |
| MME | Mobility Management Entity |
| MNC | Mobile Network Code |
| NF | Network Function |
| NID | Network Identifier |
| NRF | Network Repository Function |
| NRID | Networked Remote Identification |
| NSAC | Network Slice Admission Control |
| NSSF | Network Slice Selection Function |
| OS | Operating System |
| OS Id | OS Identity |
| ProSe | Proximity based Services |
| ProSeP | 5G ProSe policy |
| PTI | Procedure Transaction Identity |
| P-TMSI | Packet Temporary Mobile Subscriber Identity |
| RAI | Routing Area Identity |
| RID | Remote Identification |
| RRC | Radio Resource Control |
| SWG | Serving Gateway |
| SMF | Session and Mobility Management Function |
| SM-PCO | Session Management PCO |
| SNPN | Standalone Non-Public Network |
| S-NSSAI | Single Network Slice Selection Assistance Information |
| SRB | Signalling Radio Bearer |
| SSC | Session and Service Continuity |
| SSID | Service Set Identifier |
| SUCI | Subscription Concealed Identifier |
| SUPI | Subscription Permanent Identifier |
| TA | Tracking Area |
| TAI | Tracking Area Identity |
| TEID | Tunnel Endpoint Identifier |
| TNAN | Trusted Non-3GPP-Access-Network |
| TNAP | Trusted Non-3GPP Access Network |
| TNGF | Trusted Non-3GPP Gateway Function |
| TPAE | Third Party Authorized Entity |
| UAS | Uncrewed Aerial System |
| UAS NF | Uncrewed Aerial System Network Function |
| UAV | Uncrewed Aerial Vehicle |
| UAV-C | Uncrewed Aerial Vehicle Controller |
| UDM | Unified Data Management |
| UDR | Unified Data Repository |
| UPDS | UE policy delivery service |
| UPSI | UE Policy Section Identifier |
| URSP | UE Route Selection Policy |
| USIM | Universal Subscriber Identity Module |
| USS | UAS Service Supplier |
| UTM | Uncrewed Aerial System Traffic Management |
| UUAA | USS UAV Authorization/Authentication |
| UUID | Universal Unique Identifier |
| V2X | Vehicle-to-Everything |
| V2XP | V2X policy |
| WLANSP | Wireless Location Area Network Selection Policy |

1. A method performed by a network equipment, the method comprising:
transmitting, to a first network entity, a registration request message comprising a requested user equipment (UE) policies information element, the registration request message identifying a second network entity;
receiving, from the first network entity, a registration accept message;
responsive to receiving the registration accept message, starting a first timer; and wherein:
if a policy message is received from the second network entity via the first network entity before the first timer has reached a first time threshold, stopping the first timer or transmitting, to the second network entity via the first network entity, a reply message, or both; or
if the first timer has reached the first time threshold without the policy message being received from the second network entity via the first network entity, transmitting, to the second network entity via the first network entity, a UE policy provisioning request message.

2. The method of claim 1, further comprising starting the first timer in response to receiving an indication from the first network entity that the second network entity supports policy provisioning for a service, wherein the policy provisioning for the service is defined at initial registration.

3. The method of claim 1, wherein the registration request message comprises a first payload container comprising a UE state indication message comprising one or more information elements or a requested UE policies information element.

4. The method of claim 1, wherein the registration request message comprises a first payload container having a payload container type set to a value of UE policy container.

5. The method of claim 1, wherein the registration request message comprises a first payload container having a payload container type that identifies the second network entity.

6. The method of claim 1, wherein the registration request message is configured to trigger a UE-requested vehicle-to-everything (V2X) policy provisioning procedure or a UE-requested ProSe policy provisioning procedure.

7. The method of claim 1, wherein the policy message comprises a rejection or a command or request to provide a response for the second network entity.

8. The method of claim 7, further comprising, in response to the policy message comprising the command or request to provide a response to the second network entity:
transmitting, to the second network entity via the first network entity, a first reply message in response to instructions received in the command or request being successfully executed; or
transmitting, to the second network entity via the first network entity, a second reply message in response to one or more received instructions in the command or request not being successfully executed.

9. The method of claim 1, wherein the UE policy provisioning request message comprises a requested UE policies information element and is transmitted in a second payload container of an uplink (UL) non-access stratum (NAS) transport message.

10. The method of claim 9, wherein the second payload container having comprises a payload container type set to a value of UE policy container.

11. The method of claim 1, further comprising starting a second timer in response to the first timer reaching the first time threshold without the policy message being received from the second network entity via the first network entity.

12. The method of claim 11, further comprising retransmitting, to the second network entity via the first network entity, the UE policy provisioning request message in response to the first timer reaching the first time threshold without the policy message being received from the second network entity via the first network entity.

13. The method of claim 12, further comprising transmitting, to the second network entity via the first network entity, the UE policy provisioning request message and restarting the second timer in response to the second timer reaching a second time threshold without the policy message being received from the second network entity via the first network entity.

14. The method of claim 13, wherein transmission of the UE policy provisioning request message is only attempted a limited number of times, each responsive to the device not receiving a command or a rejection message.

15. The method of claim 1, wherein:
the first network entity is an Access and Mobility Management Function (AMF); and
the second network entity is Policy Control Function (PCF).

16. A network equipment, comprising:
at least one memory; and
at least one processor coupled with the memory and configured to cause the network equipment to:
transmit, to a first network entity, a registration request message comprising a requested user equipment (UE) policies information element;
receive, from the first network entity, a registration accept message; and
responsive to receiving the registration accept message, start a first timer; wherein:
if a policy message is received from the second network entity via the first network entity before the first timer has reached a first time threshold, stopping the first timer or transmitting, to the second network entity via the first network entity, a reply message, or both; or
if the first timer has reached the first time threshold without the policy message being received from the second network entity via the first network entity, transmitting, to the second network entity via the first network entity, a UE policy provisioning request message.

17. The network equipment of claim 16, wherein the at least one processor is configured to, if the policy message is received from the second network entity via the first network entity before the first timer has reached a first time threshold, stop the first timer or transmit, to the second network entity via the first network entity, a reply message, or a combination thereof.

18. The network equipment of claim 16, further comprising a second timer, wherein the at least one processor is configured to, if the first timer has reached the first time threshold without the policy message being received from the second network entity via the first network entity, start the second timer and transmit, to the second network entity via the first network entity, the UE policy provisioning request message.

19. A method performed by a user equipment (UE), the method comprising:
transmitting, to a first network entity, a registration request message comprising a requested UE policies information element, the registration request message identifying a second network entity;
receiving, from the first network entity, a registration accept message; and
starting a first timer responsive to receiving the registration accept message;
wherein:
if a policy message is received from the second network entity via the first network entity before the first timer has reached a first time threshold, stopping the first timer or transmitting, to the second network entity via the first network entity, a reply message, or both; or
if the first timer has reached the first time threshold without the policy message being received from the second network entity via the first network entity, transmitting, to the second network entity via the first network entity, a UE policy provisioning request message.

20. The method of claim 19, wherein the UE policy provisioning request message is transmitted to the first network entity, and the first network entity transparently transmits the UE policy provisioning request message to the second network entity.

21. (canceled)
